(19) United States
(12) Patent Application Publication
(10) Pub. No.: US 2006/0048016 A1
(43) Pub. Date: Mar. 2, 2006

(54) Method for a supply chain production process

(76) Inventors: Jutta Reindler, Nurnberg (DE); Thomas Weller, Forchheim (DE)

Correspondence Address: BRINKS HOFER GILSON & LIONE, P.O. BOX 10395, CHICAGO, IL, 60610, US

(21) Appl. No.: 10/927,932

(22) Filed: Aug. 27, 2004

(51) Int. Cl. G06F 11/00

(52) U.S. Cl. 714/47

(57) ABSTRACT

A method for controlling a supply chain management in product updates includes, first, a product change project that is determined by defining a type and version of equipment or systems to be changed and defining deadlines for work kits. These deadlines are completion dates for the production of a product update. Next, one or more of the work kits is processed, and an outcome of the work kits includes at least one indication pertaining to a manpower requirement for an implementation of the product change. Information about the type and version of the equipment or systems to be changed and the deadlines for the work kits are forwarded to at least one service organization. Information is then received from the at least one service organization about the available working capacity. Finally, product change quotas are defined as a function of the defined manpower requirements for the implementation of the respective product change and of the received information about the availability of working capacity.

### BACKGROUND

The invention relates, in general to a method for a supply chain production process when product changes are produced. The method further pertains to a coordination of the process of producing one or more product updates, a planning of work kits required for implementing the product updates, a planning for labor and materials needed, a planning for producing customer information documents, and a planning of the implementation of product updates in equipment and systems that are already installed on the market or at the customer.

A supply chain management (SCM) is a process for monitoring production or manufacturing processes. SCM is configured to ascertain all the input and output variables of such a process, to acquire current values at any given time of all the variables, and to evaluate the acquired values to enable controlling the applicable production process. The control can for instance be that as a function of the evaluation of the acquired values sub-processes of the supply chain management process (SCM process) are triggered. For instance, such a sub-process can be triggered if certain needed materials in the production process are no longer available in sufficient quantity or numbers. In that case, the sub-process can accomplish a procurement of the needed materials in declining supply, for instance by generating an appropriate request for a vendor of needed materials for a further production process to produce these needed materials.

SCM is typically configured to monitor and control the entire production process such that first, a rational work procedure with correspondingly high efficiency is made possible, and second, an outcome and duration of the production process can be planned and calculated in advance such that reliable statements can be made about product characteristics and market launch dates or customer shipping dates. What a given production process produces may equally well be a material, an item of equipment, a software product, a service, or any arbitrary other product.

However, SCM may not pertain only to the first time a product is produced per se. Changes (updates) to products already on the market are also included; regardless of whether the change affects hardware, software, or an installed process. Product changes may become necessary for manifold reasons, which are expressed in product change requests. These product change requests can be formulated as so-called change requests or complaints from users of the product. These product change requests can also be presented as a reaction to the finding of possible sources of error in the product. These product change requests can furthermore be due to legal requirements, such as data security or operating safety of a product, or contractual conditions. SCM also includes product change requests.

Both the coordination of many product change requests and the processes required for implementing a given product change, and the process steps in a production process, are controlled and monitored. This includes planning for working capacity and material for implementing the actual product change, generating customer information letters or customer documentation, training applications specialists in the use of special, complex applications, and planning in terms of capacities and completion dates.

However, conventional SCM processes offer no capability of adapting the process for implementing a product change, in the product already installed at a customer or on the market, to the working or service capacities available for the actual installation of the product change.

### BRIEF SUMMARY OF THE INVENTION

The present invention is defined by the appended claims. This description summarizes some aspects of the present embodiments and should not be used to limit the claims.

One object is to optimize the update process chain, from development through production/procurement to regional technical support on-site at the customer, if a correction is to be made in equipment or systems already installed at the customer.

A further object is to create a method for implementing product changes that in terms of numbers of units, i.e. quotas, or completion dates can be adapted to an expected limited working capacity available for implementing the method.

A further object is to disclose a method for implementing product changes that in terms of quotas and completion dates can be adapted to the expected available working capacity of those service organizations or service providers that are to install a product update, produced by the method, in existing systems or equipment.

A further object is to disclose an SCM process for producing product updates that in terms of quotas and completion dates or market launch dates can be adapted to the expected available working capacity of those service providers or service organizations that are to install the product update in already installed systems or equipment.

Still another object is to disclose an SCM process for implementing product changes that in terms of quantities or quotas or market launch dates can be adapted to the expected working capacity available for the implementation.

Another object is to disclose an SCM process for implementing product changes, such as changes to execute an adaptation with respect to quotas and completion dates of product updates to current or expected SCM processes to be executed at the same time for producing further, different product updates, using at least in part the same working capacity.

Another object is to disclose a method for controlling supply chain management in product updates. The method includes, first, that a product change request is defined. Next, a product change project is defined as a function of one or more product change requests, by defining the type and version of the equipment or systems to be changed, defining at least one work kit, where equipment or a system that has already been installed can be changed by working through all the work kits, and defining deadlines for work kits. Further, one or more of the work kits, that contain research or development activities for technical implementation of the product change, are processed, and the outcome of the one or more work kits includes at least one product update, an indication pertaining to material requirements for furnishing this product update and an indication pertaining to a manpower requirement for the implementation. Next, the number of types of equipment or systems to be changed is ascertained. Then, information about the availability of materials required for furnishing the at least one product update is ascertained. Further, information about the availability of working capacity for the at least one product update is also ascertained. Finally, product change quantities or quotas are defined as a function of the number of types of equipment or systems to be changed, the defined material requirements for the respective product update or updates to be executed and the availability of material, and the defined manpower requirements for the respective product update or product updates to be executed and the availability of working capacity.

The term “product update” is to be understood as a packet (kit) for changing a product that is already installed at the customer or on the market. A product change can accordingly be implemented by installation or playback of a product update. The term “product” is to be understood to mean hardware systems or equipment as well as software systems or installed production or service processes. Examples of product updates may be software patches for updating to a newer software version, for instance, or spare parts, for replacement by exchange, which are improved in terms of quality or other requirements, for equipment, or revised method steps as components for instance of production processes or service processes that have been installed at a customer by the vendor of the product update, or spare parts for retrofitting, created in response to customer wishes or quality requirements (legally or contractually required, for instance) for equipping already installed equipment or systems.

The term “request for change” is to be understood to mean a defined wish for change, which can for instance be a customer's change request for adaptation of a product to customer needs, or a change request for implementing changes in order to meet legal or contractual requirements and conditions, or a change request for correcting errors in the installed product, or a change request for bringing a product in line with the state of the art that has been developed further since the product was introduced. Requests for change are initiated, for instance when system weaknesses are found, through:
permanent monitoring of the installed products (remote monitoring, or by analysis of service technician field reports);
complaints from users/customers or escalations; and
official or government requirements.

The term “work kit” is to be understood to mean groups of work steps that belong together in the production process and that can for instance include the development of a modified hardware or software component as part of a product update; the development of a training plan and suitable training documentation for training the service technicians or applications specialists who will be responsible for installing the product update in the installed system or who are to be trained to deal with the changed products; the development of a business plan, material costs, labor costs, and other commercially relevant aspects of the production process, for the product update; or generating revised user manuals for the product to be changed, information letters for those customers who are users of the product to be changed, or recall or information letters to the customers of a product that are to be changed because of functional or safety-related defects. The term “furnishing product updates” is to be understood to mean furnishing a software patch, produced in the context of the method, or retrofitting or spare parts or a revised process step for a production or service process installed at the customer, while the term “implementing the product update” is to be understood to mean performing the entire process change, from planning through production to offering and installing product updates in equipment or systems already installed on the market.

Still another object is to disclose a method for controlling supply chain management in product updates. The method includes, first, that manpower requirements for the implementation of further, other product updates be ascertained. Next, material requirements for furnishing further, other product change requests are also ascertained. Further, product change quotas are defined as a function of the defined material requirements for the respective product update or updates to be executed, the defined material requirements for the additional product updates, and the availability of materials, and the defined manpower requirements for the respective product update or product updates to be executed, the defined manpower requirements for the further, other product updates, and the availability of working capacity.

One advantageous feature enables a vendor of product updates for a product to be changed to adapt the production process for the product update, in particular to the working capacity available at the time, that is, the capacity that is available for installing the product update in the product or equipment already installed at the customer. The adaptation can prevent product change quotas from being set that are substantially high, for instance in relation to the total available technician working capacity.

The product change quotas include both the essential identifying data for the production process for the product update and the scheduled numbers pertaining to the actually implemented changes in equipment or systems already installed at the customer. Excessive product change quotas thus mean that the production process for product updates produces an excessively high output in terms of quotas. In other words, too many product updates are produced, which means that too much material and working capacity were invested in the production of the product updates. The investments in the production process are disproportionately elevated because of the fact that, in the absence of sufficient working capacity, immediate installation of the product updates cannot be accomplished, and as such production was unnecessarily done for the sake of stockpiling.

Another advantageous feature enables the producer of a product update for already installed equipment and systems to plan product change quotas not only as a function of the working capacity available for the installation but also as a function of product change quotas and working capacity planned for the production of other, further product updates. This feature is advantageous for those producers who simultaneously handle many product change requests, which can be traced back for instance to the most various change requests for one and the same product, or to many change requests for a plurality of different products.

For instance, a producer of imaging medical equipment may offer a product line encompassing many hundreds of products all or at least some of which are installed at the customer or on the market and maintained by the same service organizations or service providers. In such a situation, work will be done simultaneously on just as many product updates, yet because of the naturally limited working capacity of the service organizations, the product updates cannot all be installed simultaneously in products that are already at the customer. As such, another advantageous feature enables avoidance of bottlenecks in this respect that are due for instance to the fact that a plurality of product updates for different items of equipment are to be produced simultaneously and introduced simultaneously at the customer.

Still another advantageous feature enables to adapt production processes for product updates to all the demand variables, in particular manpower requirements, in relation to the respective supply variables, in particular the working capacity, and in this way to achieve substantially better capability of planning in terms of numbers of units produced and production dates. More reliable planning in terms of numbers of units, i.e. quotas, and dates for instance enables the producer to send more accurate advance plans to national government agencies, such as the FDA (Food and Drug Administration) in the case of medical technology producers, and thus to make more-efficient collaboration possible, or to make more-exact statements as to launching product updates on the market to the service organizations responsible for the product updates, so that these organizations can in turn plan to meet their demand accordingly, for instance so that announced updates can be coordinated with maintenance procedures that are due anyway, or to keep the appropriate working capacity available in advance for installing updates of high priority, for instance in the case of safety-related defects or changes in legal requirements.

Optimizing an installed product via a product change or a product update is accordingly done as a function of the urgency of the individual update measure (because of official or government requirements, retrofits for instance are to be concluded within defined periods of time), taking into account costs and execution time and the limited capacities of the various resources, such as development tasks, availability of materials, and production and technician capacity. The various resources are planned jointly, and their availability can be assured by forecast.

Further characteristics and advantages of the invention will be described below in conjunction with preferred exemplary embodiments and in conjunction with drawings; the characteristics in the description or drawings are to be understood as in no way limiting to the claims. The exemplary embodiments include a method for controlling supply chain management in product updates.

### BRIEF DESCRIPTION OF THE DRAWINGS

The components and drawings need not necessary be to scale and instead serve merely to schematically illustrate the fundamental concepts of the invention.

FIGS. 1a-d schematically show a method sequence for the production of a product update; and

FIGS. 2a-c schematically show the dependencies for planning a process for implementing a product update.

### DETAILED DESCRIPTION OF THE DRAWINGS AND PREFERRED EXEMPLARY EMBODIMENTS

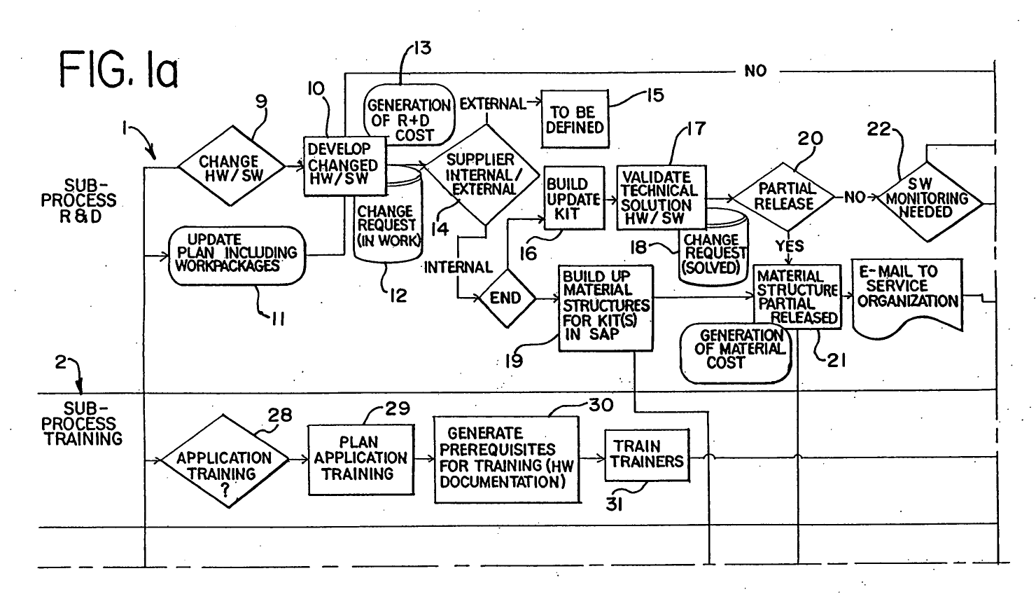

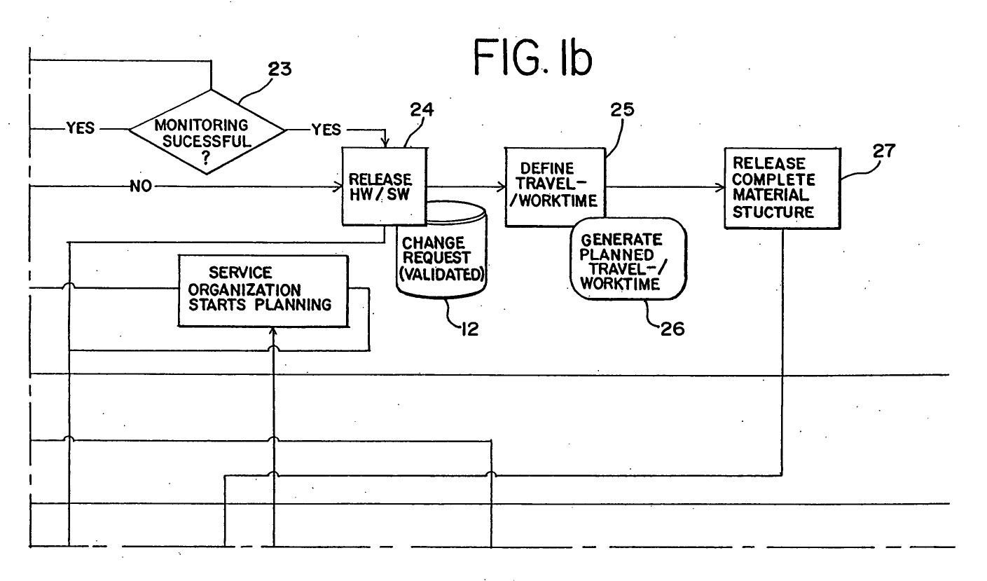

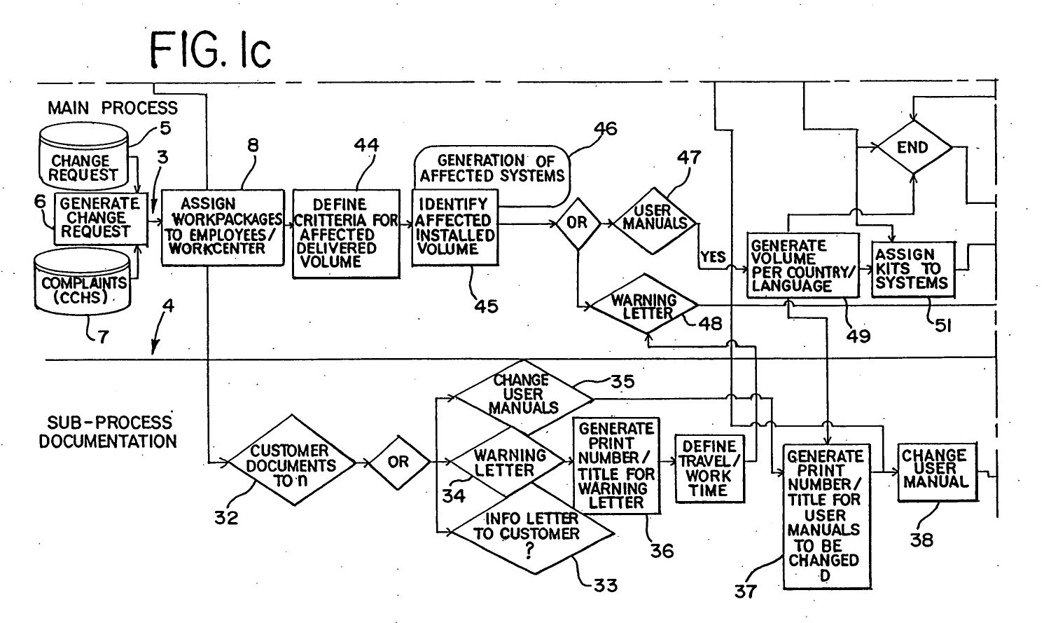

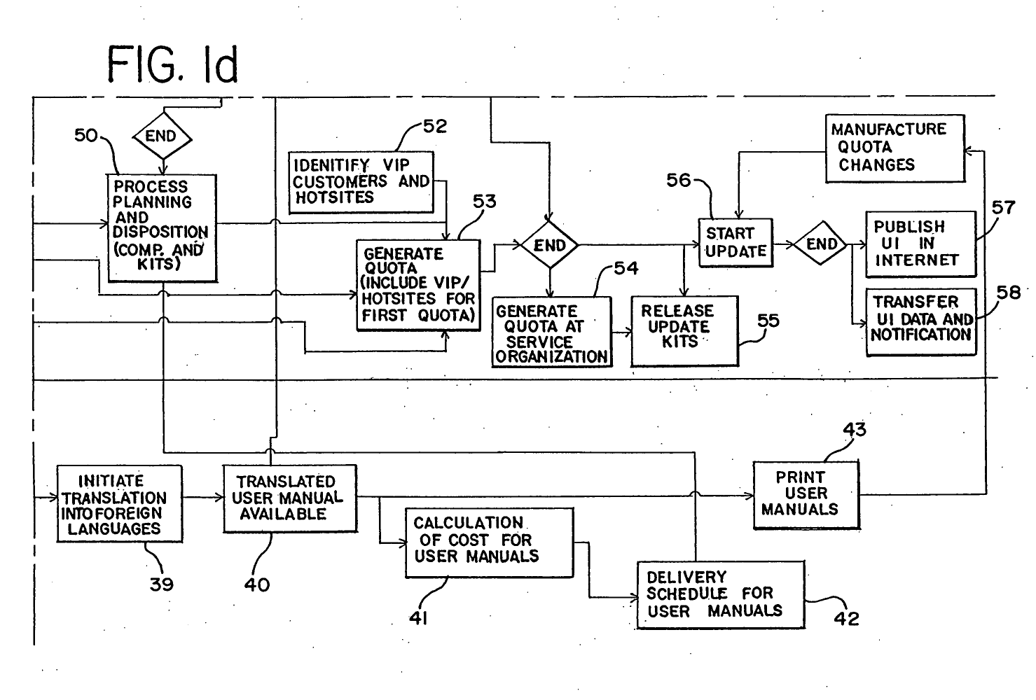

FIG. 1 is a exemplary emdobiment and is composed of the individual FIGS. 1a, 1b, 1c and 1d; such that 1a corresponds to a top left section, 1b to a top right section, 1c to a bottom left section, and 1d=bottom right section of FIG. 1. In the ensuing drawing description, the reference numerals and code names of elements are each shown in the drawings.

FIG. 1 schematically shows a method sequence for producing product updates. The product updates may be hardware changes, software changes, or changes to production processes or service processes.

A starting point of the method is a presence of at least one product change request, in the form of a change request or a complaint. Complaints are criticisms from customers who use the product to be changed and who are unsatisfied with the product's performance or reliability. Complaints are received by telephone, in writing, or electronically and are collected in a database intended for them. Change requests can also originate with customers who are users of the already installed product and can for instance pertain to their wishes for improved adaptation of the products to their needs. However, change requests can also originate in changes in legal conditions, which can have to do for instance with data security in handling customer data or medical data (Heath Information Privacy Act Agency (HIPAA)), safety requirements for the operation of equipment, or reliability requirements from the medical standpoint. Like complaints, change requests are received orally, in writing or electronically and collected in a database intended for them.

The accumulated change requests and complaints are analyzed by a person, such as a product manager, who is responsible for them and who based on his analysis defines a change request as a product change request. This product change request can be in response to one or more change requests or complaints and can pertain to one or more characteristics of the affected product. At a termination of the process is the production of a prototype (first kit), which represents a first copy of the product update. The prototype can include a software patch, a retrofitting part, or a spare part for equipment, or a changed definition for partial steps in a production or service process, or possibly revised user documentation, such as a manual, and in addition, appropriate product change announcements, for instance in the form of information letters, for the user of the product. Accordingly, the method includes schematically the work and planning steps that are needed for producing the product update and shipping to the customer. It can therefore be understood as a method of supply chain management. This method is broken down or divided into four parallel handling lines shown as horizontal lines separated vertically from one another by dashed lines.

Referring to FIG. 1a, the first line (Sub-Process R&D) 1 relates to the development of changes in hardware or software. The second line (Sub-Process Training) 2 relates to planning and setting up training materials to be made available to service providers or applications specialists so that they can be trained in installing the applicable product update and in dealing with the changed product. The third line (Main or Central Process) 3 relates to the overall organization and coordination of the work steps or work kits of the other lines and in this respect can be understood as a main process that coordinates the other three lines, which are sub-processes. The fourth line (Sub-Process Customer Documentation) 4 relates to generating changed user documentation, such as user manuals, and information to users through corresponding information letters or warnings. The individual processes and sub-processes in the supply chain will be described in further detail hereinafter.

Once the change request 5 has been defined by the responsible person as a product change request, then in the next step 8, work kits are assigned to individual employees or work groups (shown all the way to the left in the main process in the drawing). If a change is to be made in a hardware or software product at step 9, then employees or work groups in corresponding research and development departments (R&D) are given an assignment accordingly to develop product updates at step 10. Accordingly, in the sequence plan, the R&D sub-process is triggered by the main process. For that purpose, a change plan with work kits is transferred to the R&D sub-process, at step 11.

In the R&D sub-process (Sub-Process R&D), an additional database 12 can be provided, for managing changes that were transferred with the change plan. This is designated in the drawing as “Change Request (in work or progress)”. The task of the sub-process (Develop Changed Hardware (HW)/Software (SW)), at step 10, is analyzed in such a way that financial, material and work force-related R&D costs are calculated (Generation of R&D Cost) 13. Next, a decision is made as to whether the product changes, according to the change plan, should be developed internally or externally (Supplier internal/external), at step 14. If the decision is for external development, then a corresponding job is defined and assigned to an external service provider, at step 15.

If the decision is to develop the product update internally, then first the corresponding internal development takes place. As such, a product update packet is developed (Build Update Kit), at step 16, and the technical solution developed in it is then validated (Validate Technical Solution HW/SW), at step 17. Attaining a validated solution is understood to be a conclusion of a first essential work step, on the order of a milestone, and corresponding validated product changes are stored in the database for managing product changes (Change Request (solved) 18). Simultaneously with the development of the product change kit, appropriate piece lists are generated on the organizational or logistical level; the management of the piece lists is preferably done via a program such as SAP that is on the market (Build Up Material Structures for Kit in SAP) at step 19.

One feature of software (SW) updates is that, like SW products, they may comprise independent functional components. For such independent SW update components, accordingly independent SW work kits can be defined, which can be released independently (partial release), at step 20. On the precondition that a current product change kit has been at least partly released (Partial Release), the piece lists in SAP corresponding to this released change kit are also released (Material Structure Partial Released), at step 21. At this point in time, all the logistical and commercial information for the change kits currently to be released is available, so that in conjunction with the entries in the piece lists, the corresponding material costs or the corresponding demand for material is indicated.

Updates that cannot be released component by component or kit by kit are subjected to quality control, in which it is ascertained whether further control or monitoring, for instance by online monitoring of certain test systems in the field, is needed (SW Monitoring Needed?), at step 22. If the answer is yes, then by further quality control it is ascertained whether the particular SW update is functioning without error (Monitoring Successful?), at step 23. If that is not the case, the development process (Develop Changed HW/SW), at step 10, is triggered once again.

If the final total release is either completely unnecessary or can be successfully issued, then the final release of the product update takes place (Release HW/SW), at step 24. Simultaneously with the issuance of the final release to the database for administering change kits (Change Request (validated)) are updated accordingly, so that a piece list of all the validated product change kits can be taken from the Change Request database 12.

Following the final release, a calculation is made as to how much working capacity and possibly also travel time are needed (Define Travel time/Work time) for installing the released product update in equipment or systems at the customer, at step 15. As the outcome of this calculation, a planned work and travel time per system or type of equipment is obtained (Generate Planned Travel time/Work time) 26. This information can be used by the service provider, who is to install the released product update at the customer, to do advance or preliminary planning for his manpower requirements. Thus even before the product update is actually shipped, he has information available on manpower requirements and can then use this information to optimize preliminary planning for the date of shipment of the product update and as a function of that to order quantities of the product update that he will be capable of installing in accordance with the preliminary planning.

In a terminating step 27 of the R&D sub-process, the complete piece list entry for a product update, which includes all the information on material requirements, production costs and installation expenditure, can be released (Release Complete Material Structure).

As the starting variables, the R&D sub-process thus furnishes both piece list entries of partly released change kits and piece list entries for finally released product updates to the central control process.

Simultaneously with the R&D sub-process, the training sub-process (Sub-Process Training) for controlling measures for training applications specialists can be triggered by the main process, at step 28. An object of this sub-process is training for applications specialists, who in turn train the customers where the various products are installed. The applications specialists working on-site are first to be trained by the producer (Plan Application Training), at step 29. Additionally, documentation for the customers that accompanies the training is to be prepared. Training measures can impart knowledge, not only for instance about how to incorporate or install software patches and how to renovate spare parts or install retrofitting parts, but also about how to deal with new product properties that come along with product updates.

The planning for these training measures also includes planning the intensity or time needed for training measures, so that applications specialists to be trained can be prepared for the training expenditure, in effort and/or expense, involved and can plan for this in advance. In particular, training measures are if at all possible planned along with the onset of development of product updates, by triggering the corresponding training sub-process simultaneously with the R&D sub-process. This makes it possible for the applications specialists to plan for the required training measures even before a product update is launched on the market and conversely to order product updates to fit the scope of planned training measures. For instance, if a realization of the training measures is to be delayed because of bottlenecks in working capacity, this can be taken into account by ordering the product update for a later date, by which time it will definitely be possible to accomplish the training measures.

After the planning for training measures, at step 29, documentation for these measures are generated, such as manuals or training equipment (Generate Prerequisites for Training (HW documentation)), at step 30.

At a concluding step 31 in the training sub-process, tutors are trained (Train Trainers), who have the task of performing training measures. An outcome of this is that the training sub-process furnishes the main process with a catalog of tutors available for training measures and also provides it with information on the manpower requirements to be included in planning for training measures in conjunction with the particular product update.

The customer documentation sub-process (Sub-Process Customer Documentation), shown in FIG. 1c, is also started simultaneously with the three sub-processes described above. This sub-process has the task of generating information letters at step 32 to customers (Infoletter or Information Letter to Customer?) 33, warnings (Warning Letter?) 34 or revised user manuals (Change User Manuals?) 35.

In case of a high-priority warning, a reference number for a corresponding information letter is generated (Generate Print Number/Title for Warning Letter), at step 36. Next, prices and manpower requirements, which are to be included in the planning along with the information letter or the product update for correcting the product's characteristic that was the reason for the update, are calculated. In that case, the sub-process customer documentation furnishes information about the availability of the warning to the main process along with the working capacities to be included in the planning in this respect.

If user manuals have to be changed, then the sub-process generates a reference that identifies the user manuals to be changed accordingly (Generate Print Number/Title for User Manuals to be Changed), at step 37. From the main process, the sub-process learns the number of user manuals to be changed per country or per language and then makes the required changes (Change User Manual), at step 38.

In accordance with the information on countries and languages received from the central process, translations are then initiated (Initiate Translation into Foreign Languages) at step 39, and after the translations have been completed information is generated that indicates that translated user manuals are available (Translated User Manual Available), at step 40. This information is made immediately available to the service provider or a service field planning office in a service region that is entrusted with installing the particular product update at the customer.

In a next step 41, the sub-process customer documentation calculates the costs for generating the user manuals (Calculation of Cost for User Manuals), furnishes this information to the main process, then defines a delivery schedule for changed user manuals (Delivery Schedule for User Manuals) at step 42, and also furnishes this information back to the main process. Parallel to this, printing of revised user manuals is begun (Print User Manuals) at step 43.

Accordingly, the customer documentation sub-process processes the printing of revised user manuals or warning letters simultaneously, by first furnishing information about the availability and the price of these printed products to the central process. The central process can in particular schedule shipping dates for user manuals, in order for instance to assure that the associated product updates will not be completed for launching on the market before the revised user manuals.

The central process (Main Process) has the task of triggering and coordinating the sub-processes described above. All the information paths therefore begin at the central process and are united again in it.

In a first step 44 within this process, criteria are defined for identifying the equipment and systems affected by a product update (Define Criteria for Affected Delivered Volume). Next, it is ascertained which affected products are in fact installed at the customer (Identify Affected Installed Volume), at step 45. As a function of this assertion, a catalog of the systems actually affected, together with the respective customers, can be generated (Generation of Affected Systems), at step 46.

As a function of the catalog of affected systems, either the generation of revised user manuals (User Manuals), at step 47, or the generation of corresponding warning letters (Warning Letter), at step 48, is triggered. For revised user manuals, it is ascertained what quantities are needed for which country or language (Generate Volume per Country/Language), at step 49. This information is made available to the sub-process customer documentation. Simultaneously, this information is linked with the information about partly released change kits and the information about completed released product updates and is transferred to the next process step for planning more of the process (Process Planning and Disposition (completion and kits)), at step 50. Moreover, the information about quotas are assembled together with the quota entries for partly released change kits to make change kits for affected products (Assign Kits to Systems), at step 51.

The change kits are used, together with the information about scheduling released product updates or partly released change kits, in order in an ensuing step 52 to define quotas for product updates (Generate Quota (incl. VIP/Hot sites for First Quota)). At step 52, these quotas can be calculated taking very important customers (VIPs) and so-called hot sites into consideration (Identify VIP Customers and Hot sites). Hot sites are products or systems where technical problems have occurred to an increased extent and have escalated in the service process.

At a next step 54, the quotas available for the applicable service organization or service provider are defined (Generate Quota at Service Organization), and the corresponding kits are released (Release Update Kits), at step 55.

In the next step 56, production of the product update is started (Start Update), and the related information is then communicated to the service regions (Publish UI (Update Information) in Intranet), at step 57, and associated data and information are made available (Transfer UI Data and Notification), at step 58. After the quota entries have been generated, the service organization or service provider entrusted with installing the product updates in the devices and equipment that have already been installed at the customer are informed of the release of new change packets (E-mail to Service Organization). The service provider, based on this information about change kits, can already begin to schedule maintenance work and working capacities required for this (Service Organization Starts Planning). Thus, even before a final product update that can be launched on the market is available, information announced in advance is already sent to the service provider in order to enable that person or organization to begin preparations and planning now for the release of the final, complete product update.

Accordingly, the central process starts the production of the product update, in accordance with the information about material requirements and manpower requirements contained in the various sub-processes R&D, training and customer documentation, in suitably adapted quotas (Manufacture Quota Charges).

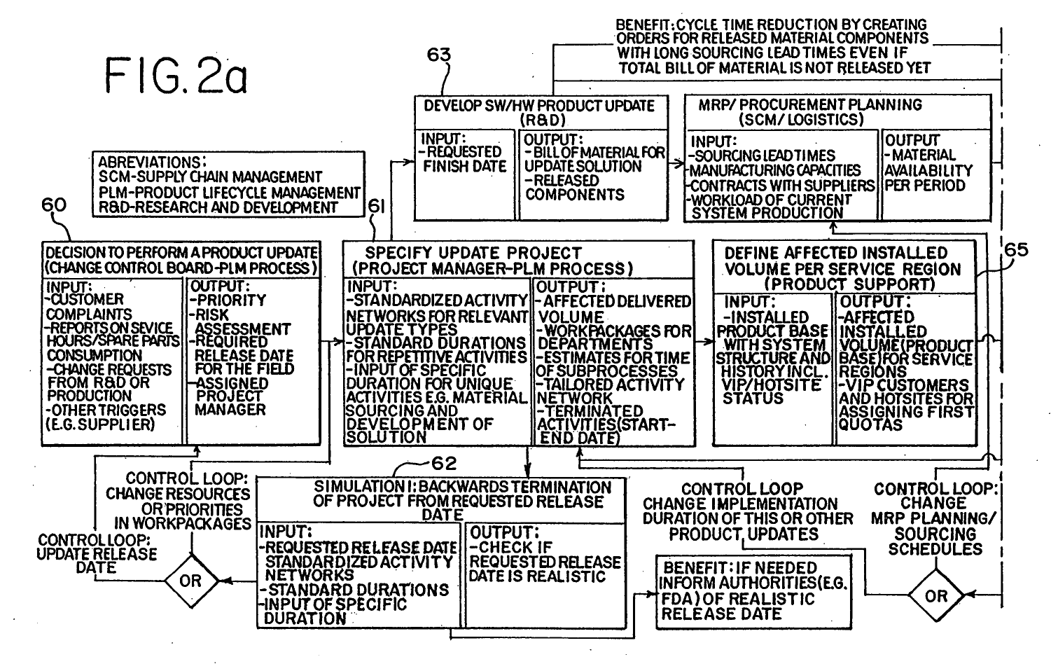

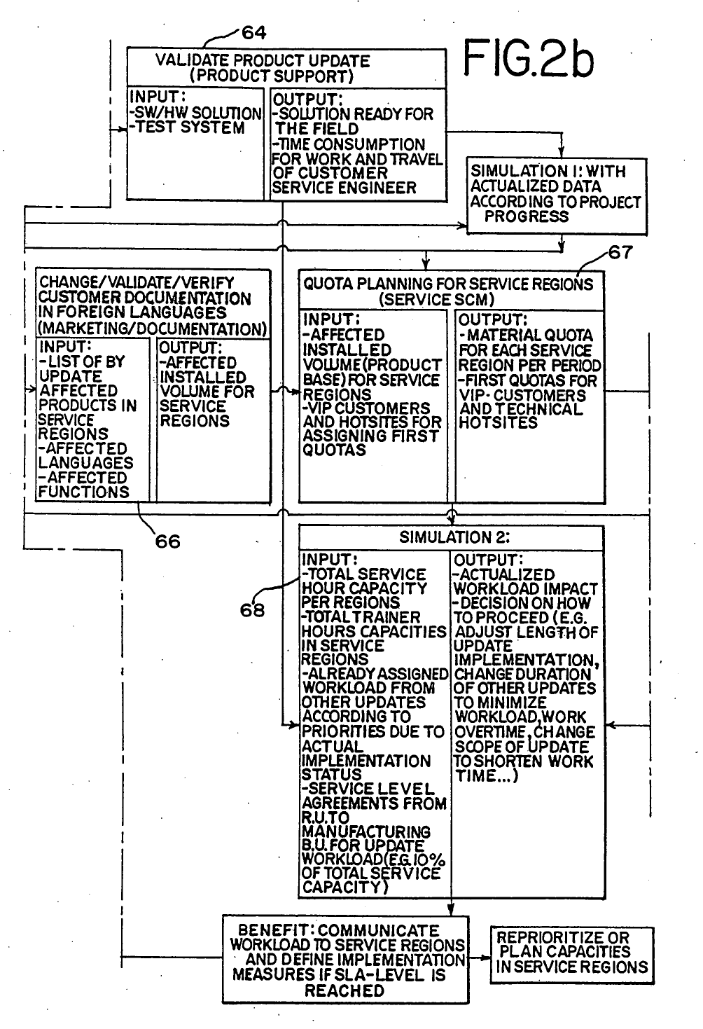

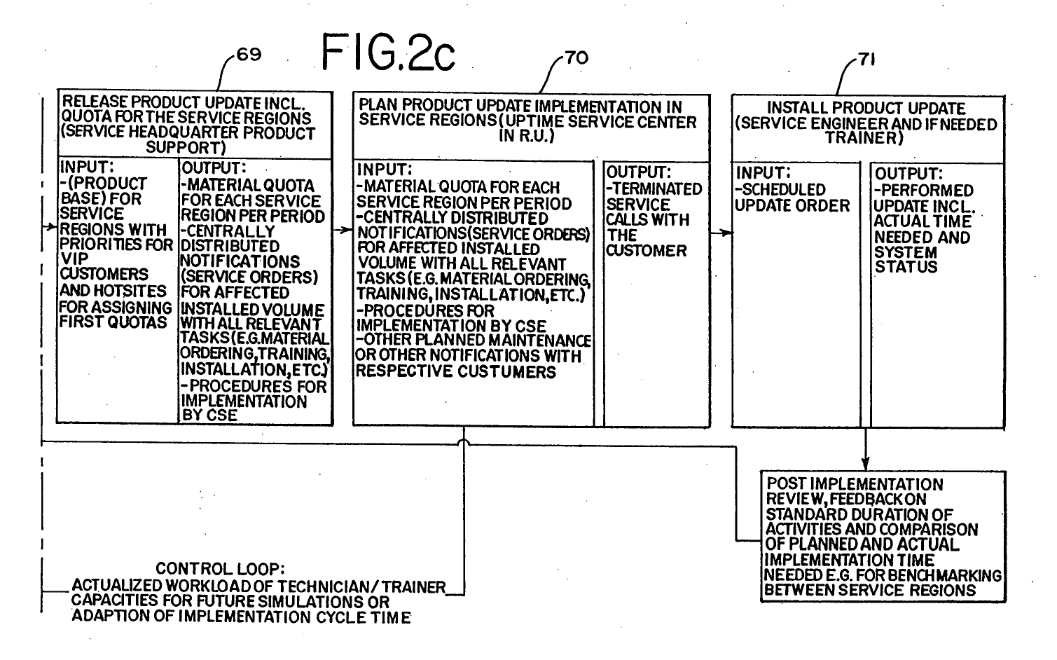

In FIGS. 2a-2c, a sequence for a method for controlling product updates is shown schematically in logical blocks, which can each contain many work steps and information paths in the process sequence described above in conjunction with FIG. 1. In FIGS. 2a-2c, one aspect is shown, which comprises adapting the SCM process to the working capacity required for implementing product updates.

In a first block 60 of FIG. 2a, on the basis of customer complaints, reports from service organizations, product development cycles or other input variables, the decision is made to define a product change request. As the outcome of this decision, a priority is allocated, risks are assessed, a binding release date for the market launch is defined, and a product manager for the project of producing the product update is assigned. A product update can involve one or more product change requests.

In the next block 61, the product update project is defined. Here standard work networks for various types of update are employed; known activities that are repeated constantly are taken into account; durations for unique, special activities are evaluated; and as an additional input variable, an outcome of a simulation of the update process (shown in FIG. 2a in the block below Simulation 1) is taken into account. The simulation of the update process, shown in the Simulation 1 block 62, takes the input variables on hand up to this time (intended release date, activity networks involved, standard durations and special durations) and on the basis of these variables checks whether the projected release date appears realistic. The outcome obtained is a release date that can realistically be expected and is returned to the initial function block (definition of the update) 60 or to the second function block (definition of the update project) 61. As such, the simulated realistic release date is returned as a controlled variable, so that the definition of the update or the update project will be on a realistic basis.

From the simulation of a release date considered realistic, one advantage is to inform government agencies, such as the FDA, of this release date and thus to improve scheduling in cooperation with these agencies and thus make collaboration more efficient. As the outcome of defining the update project, development activities are started, which is shown in the block above (Develop Update SW/HW Solution R&D) 63. Following the development of a product update, the update is validated in the following block 64 at the top and is incorporated into an item list in the block shown above it.

Next to the R&D activities, in the block 65 shown in proximity of the update project block 61, is the definition of the update project, which is done by ascertaining the number of products affected by the product update in a particular service region (Define Affected Installed Volume). In block 66, the adaptation of user documentation, such as a user manual, is done.

The next block 67 shows the quota planning for shipping product updates for the individual service regions. Input variables for this block 67 are values attained from R&D on the availability of material required for the product update as well as the required work and travel time for the service technicians responsible for installing the product update. Other input variables are the equipment and systems per region that are affected by the product update. In addition, priorities or orders of priority of particular customers and for particular product updates, such as safety-relevant product updates, can be taken into account.

By using all these variables, a simulation shown in the block Simulation 2 69 below is started. As further input variables, this simulation uses the actually available working capacity in the various service regions, the available training capacities for training applications specialists, the working capacity already planned for other product updates which is thus no longer available, and service level agreements if applicable, in order to reconcile the total expenditure required for a product update per region with the total resources available in that region, and thus to optimize the work load of the service organization in that particular service region. The outcome of Simulation 2 is once again returned in the sense of a control loop to earlier function blocks of the entire project sequence, in order to vary the quota planning if necessary for the particular service region. Thus, the fact that in a service region update of high priority is to be performed, for instance, can be taken into account by increasing the quotas for that region. If adequate working capacity is not available in a service region for installing a product update at the customer on the projected date can be taken into account by reducing the quotas for that service region in favor of the quotas for other service regions or the quotas for other product updates.

Moreover, the current or updated quota planning can be reported to the particular service region affected, so better planning for impending product updates can be done by the service organization in that region.

After the conclusion of Simulation 2 and the associated control loop, realistic quota planning for the service regions is available, specifically individually for each service region or service organization. Next, in the next function block 69, the product update is released, including quota planning for the service regions (Release Update incl. Quota for Service Regions).

In the next function block 70, the service units of the respective service region plan implementing impending product updates incorporated into their work (Plan Update Implementation in Service Regions). The decisive variables for this planning for implementation cycles, such as the frequency with which product updates can be performed typically at a customer in a given service region, can be returned as an input variable to Simulation 2 in order to be taken into account in future quota planning.

In a final function block 71 (Implement Update), the particular product update is implemented or installed by the service organization for the particular customer, or in other words is installed in already installed equipment and systems, and the performance of the implementation of the update is ascertained or evaluated. As an output variable, information about products already provided with the update is furnished, and standard work times for implementing the particular product update are also evaluated, and the planned duration of the implementation is compared with the actual duration of it. These output variables are returned as an input for defining the update project (Specify Update Project) in block 61, so as to be available as input variables for planning further product updates.

From the above description of the drawings it is clear that the essential parameters of the work sequence in the actual installation of product updates at the customer are returned as input variables to the current process planning of the SCM process. Hence the resources of the SCM process can be adjusted optimally to the demand for a given service region. It is also clear that the scheduling, which is thus improved, for the market launch of product updates makes it possible to communicate exact information on projected market launch dates and update quotas early, to improve the planning capability for measures involving updating or maintenance.

One case will now be described, as an example of a practical application of the invention. Affected products may for instance be the following products made by Siemens, a producer of medical technology:
Axiom Artis X-ray system
Somatom Smile MRI system
Sequoia ultrasound system
Leonardo imaging workstation.

In all, hundreds of retrofits a year are done in such equipment, and hundreds of thousands of systems are affected.

The method described above is intended to be understood as an integrated planning tool and can be implemented in the form of software, such as in the form of a module for SAP. One object of the integrated planning is to learn early from development when a product update should be started. The integrated planning tool, which is based on a network plan that is aware of all the standardized dependencies and has access as much as possible to standardized planning values for the material requirements or manpower requirements of standard activities, calculates a planned release date. As such, the parameters relevant to production are input or planned in a way adapted to one another; examples:
availability of product components based on procurement times or procurement contracts (to be adapted in coordination with Logistics)
development time (to be adapted in coordination with Development) preparation times for the supply chain process (for instance, writing the retrofit instructions, validating the solution, putting together product kits, constructing key or core data).

From the release date, the specified lifecycle of a product in the field, the number of systems affected, the planned work and travel time, and the reports from the database, and on the basis of already-ordered retrofits with different priority stages or orders of priority (voluntary or compulsory retrofits), the planning tool calculates how large the planned capacity load on the service organization in the various service regions will be. In this process, the planned capacity is also reconciled with the actually existing capacity.

By agreement between the producer and the service regions, whose service technicians or organizations have access to the prediction values calculated by the planning tool, implementation models would then have to be defined, such as lengthening an implementation time, prioritizing certain updates and ignoring others, using addition service providers to be hired, incentives to work overtime, etc.

The conclusions drawn from working-capacity planning are taken into account in the procurement planning, so that no more product updates than can be implemented with the existing working capacity will be procured. Accordingly, forward and reverse planning are implemented to take into account various possible bottlenecks both at the producer and in service. Using a same model, the applications specialists for training measures can be planned using the planning tool.

Consistent planning with reliable planning data enables a parallelization of the development activities and the supply chain. For instance, released sub-components for product updates are procured immediately, even if the component item list for an update has not yet been completely released.

The invention has been described above in terms of various exemplary embodiments in various versions. For one skilled in the art it is clear that numerous changes and modifications, which are also covered by the central concept of the invention, can be made in the exemplary embodiments. The preceding description

1-12. (canceled)

13. A method for controlling supply chain management in product updates, including the following steps:
a) defining at least one product change request;
b) defining a product change project as a function of one or more product change requests, by:
defining a type and version of equipment or systems to be changed,
defining at least one work kit, where equipment or a system already installed is changed by working through appropriate work kits,
defining deadlines for work kits, wherein the deadlines are starting dates or completion dates;
c) processing one or more of the appropriate work kits that contain research or development activities for technical implementation of the product change, an outcome of the one or more of the appropriate work kits being at least one product update, an indication pertaining to material requirements for furnishing the at least one product update and an indication pertaining to a manpower requirement for the implementation of the at least one product update;
d) ascertaining a number of types of equipment or systems to be changed;
e) ascertaining information about availability of materials required for furnishing the at least one product update;
f) ascertaining information about availability of working capacity for the implementation of the at least one product update; and
g) defining product change quotas as a function of:
the number of types of equipment or systems to be changed,
the defined material requirements for the respective product update or updates to be executed and the availability of material, and
the defined manpower requirements for the respective product update or product updates to be executed and the availability of working capacity.

14. The method of claim 13, including the following further steps:
ascertaining information about the number of types of equipment or systems to be changed within at least one predetermined region,
ascertaining information about the availability of working capacity in the applicable region for the implementation of the at least one product update, and
defining regional product change quotas as a function of the number of types of equipment or systems to be changed in the applicable region and of the working capacity available in that region.

15. The method of claim 13, including the following further steps:
defining a priority order or priorities for equipment or systems to be changed, and
defining product change quotas as a function of the priority order or the priorities.

16. A method for controlling supply chain management in product updates, including the following steps:
a) defining at least one product change request;
b) defining a product change project as a function of one or more product change requests, by:
defining a type and version of equipment or systems to be changed,
defining at least one work kit, where equipment or a system already installed is changed by working through appropriate work kits,
defining deadlines for the appropriate work kits, where the deadlines are starting dates or completion dates;
c) processing one or more of the appropriate work kits that contain research or development activities for technical implementation of the product change, an outcome of the one or more appropriate work kits being at least one product update, an indication pertaining to material requirements for furnishing the at least one product update and an indication pertaining to a manpower requirement for the implementation of the at least one product update;
d) ascertaining a number of types of equipment or systems to be changed;
e) ascertaining information about availability of materials required for furnishing the at least one product update;
f) ascertaining information about availability of working capacity for an implementation of the at least one product update; and
g) defining product change quotas as a function of
the number of types of equipment or systems to be changed,
the defined material requirements for the respective product update or updates to be executed and the availability of material, and
the defined manpower requirements for the respective product update or product updates to be executed and the availability of working capacity.

17. The method of claim 16, including the following further steps:
defining a priority order or priorities for product change requests, and
defining product change quotas as a function of the priority order or the priorities.

18. A method for controlling supply chain management in product updates, including the following steps:
a) defining at least one product change request;
b) defining a product change project as a function of one or more product change requests, by:
defining a type and version of equipment or systems to be changed,
defining at least one work kit, where equipment or a system already installed is changed by working through appropriate work kits,
defining deadlines for the appropriates work kits, where deadlines may be starting dates or completion dates;
c) processing one or more of the appropriate work kits that contain research or development activities for technical implementation of the product change, an outcome of the appropriate work kits being at least one product update, an indication pertaining to material requirements for furnishing the at least one product update and an indication pertaining to a manpower requirement for the implementation of the at least one product update;
d) ascertaining a number of types of equipment or systems to be changed;
e) ascertaining information about availability of materials required for furnishing the at least one product update;
f) ascertaining information about availability of working capacity for the implementation of the at least one product update;
g) defining product change quotas as a function of:
the number of types of equipment or systems to be changed,
the defined material requirements for the respective product update or updates to be executed and the availability of material, and
the defined manpower requirements for the respective product update or product updates to be executed and the availability of working capacity;
h) ascertaining manpower requirements needed for the implementation of additional product updates;
i) ascertaining the material requirements needed for furnishing additional product change requests; and
k) defining product change quotas as a function of:
the defined material requirements for the respective product update or updates to be executed, the material requirements needed for the additional product updates, and the availability of materials, and
the defined manpower requirements for the respective product update or product updates to be executed, the manpower requirements needed for the additional product updates, and the availability of working capacity.

19. A method for controlling supply chain management in product updates, including the following steps:
a) defining a product change project by:
defining a type and version of the equipment or systems to be changed,
defining at least one work kit, where equipment or a system already installed is changed by working through appropriate work kits,
defining deadlines for appropriate work kits, where the deadlines may be starting dates or completion dates;
b) processing one or more of the appropriate work kits that contain research or development activities for technical implementation of the product change, an outcome of the appropriate work kits being at least one product update, and an indication pertaining to a manpower requirement for the implementation of the at least one product update;
c) ascertaining a number of types of equipment or systems to be changed;
d) ascertaining information about a availability of working capacity t for the implementation of the at least one product update; and
e) defining product change quotas as a function of:
the number of types of equipment or systems to be changed, and
the defined manpower requirements for the respective product update or product updates to be executed and the availability of working capacity.

20. The method of claim 19, including the following further steps:
forwarding information pertaining to the manpower requirements to a service organization, and
forwarding the product change quotas to the service organization.

21. The method of claim 20, including the following further step:
forwarding the deadlines for the appropriate work kits to a service organization.

22. The method of claim 19, including the following further step:
forwarding information about the type and version of the equipment or systems to be changed to a service organization.

23. A method for controlling supply chain management in product updates, including the following steps:
a) defining a product change project by:
defining a type and version of a equipment or systems to be changed,
defining deadlines for appropriate work kits, where the deadlines may be starting dates or completion dates;
b) processing one or more of the appropriate work kits, an outcome of the appropriate work kits being at least one indication pertaining to a manpower requirement for an implementation of the product change;
c) forwarding information about the type and version of the equipment or systems to be changed to at least one service organization;
d) forwarding the deadlines for the appropriate work kits to the at least one service organization;
e) receiving information about the available working capacity from the at least one service organization; and
f) defining product change quotas as a function of:
the defined manpower requirements for the implementation of the respective product change, and
the received information about the availability of working capacity.

24. The method of claim 23, wherein information about the available working capacity is received from a plurality of service organizations; and wherein the product change quotas are defined individually for each of the plurality of service organizations as a function of the information, received from the respective service organization, about the availability of working capacity.
